(19) United States
(12) Patent Application Publication
(10) Pub. No.: US 2010/0008746 A1
(43) Pub. Date: Jan. 14, 2010

(54) TIE FOR IDENTIFICATION RING

(75) Inventors: Vincent Degelis, Seyssinet-Pariset (FR); Paul Maury, Moirans (FR)

Correspondence Address: BAKER & DANIELS LLP;111 E. WAYNE STREET, SUITE 800, FORT WAYNE, IN, 46802, US

(73) Assignee: A. RAYMOND ET CIE, Grenoble (FR)

(21) Appl. No.: 12/524,286

(22) PCT Filed: Feb. 7, 2008
(86) PCT No.: PCT/EP08/00922

§ 371 Date: Jul. 23, 2009

(30) Foreign Application Priority Data
Mar. 6, 2007 (FR) 07/01623

(51) Int. Cl. F16B 5/06

(52) U.S. Cl. 411/508

(57) ABSTRACT

The invention includes a support frame for producing a dental workpiece. The frame has a Z axis and comprising wall sections defining a hole that extends along the Z axis through the frame. At least one of the wall sections comprises an adhesive-directing surface extending along the Z axis in a non-parallel relationship. Such a configuration provides optimized methods for affixing a blank to the support frame and optimized properties of the blank after fixation to the support frame.

### CROSS-REFERENCE TO RELATED APPLICATION

This application is a U.S. National Phase Patent Application based on International Application Serial No. PCT/EP2008/000922 filed Feb. 7, 2008, the disclosure of which is hereby explicitly incorporated by reference herein.

### BACKGROUND OF THE INVENTION

1. Field of the Invention

The present invention relates to a device for assembling a first panel and a second, superposed panel, which device is intended to pass axially through a hole provided in each panel and comprises a hollow-shaped fixing base equipped with clipping means for clipping onto the first panel, and a captive locking member comprising an elongated body mounted in the fixing base and a retaining head for retaining the second panel.

2. Description of the Related Art

In many fields, particularly the automotive industry, it is necessary to assemble two parts together in an area where two panels, each integral to a respective one of the two parts, are superposed. Generally, the panels have through-holes that are intended to be aligned at the time of assembly. An assembly device is then inserted in the holes to accomplish the assembly of the two panels. Such assembly devices must be designed so that they lend themselves to fast, easy mounting in hard-to-access mechanical structures, often without visual guidance, and so that they can be counted on to hold the panels in place reliably.

Prior-art devices, for example bolt and nut systems, are already capable of performing these functions. But this type of assembly device has always been hard to manipulate, since during the mounting operation it is necessary to hold the two panels against each other while at the same time inserting the bolt and screwing down the nut until tightness is obtained. The considerable mechanical complexity of this device makes it difficult to use in an automated production line. The operations of lining up the holes, holding the panels in place, and inserting and rotating the device are painstaking and laborious for a single operator to perform, which has the direct consequence of slowing assembly rates.

The document EP0591186 describes a device for assembling two superposed panels, which device is composed of a fixing base and a captive locking member mounted in the fixing base. The device is intended to pass axially through a hole provided in each of the panels. The fixing base comprises clipping means for clipping it onto the first panel. A spring is disposed between the fixing base and the locking member in such a way as to naturally keep the retaining head, which retains said locking member, within the thickness of the second panel. The retaining head has two diametrically opposed lugs and the hole in the second panel is oblong in shape, with dimensions that are similar to those of the retaining head. In order to free the retaining head from the second panel and thus be able to rotate the locking member one quarter turn, manual pressure must be applied to the locking member to counter the force of the spring. After this rotation, the lugs serve to retain the second panel on both sides of its hole.

Although it simplifies the operation of assembling the panels, such a device is not entirely satisfactory, since the rigidity that it imparts to the panel assembly is absolute, a fact that may, depending on the application, prove detrimental to safety. For instance, it is common for the first panel to be a suitable portion of an automobile chassis and the second panel a portion of a fender or the bumper of the automobile. In applications of this kind, the rigidity of the panel assembly is such that impact absorption by the fender or bumper is very poor. Meanwhile, government standards are placing increasing demands on automakers to improve safety in this respect.

### SUMMARY OF THE INVENTION

The present invention provides a device for assembling two panels.

The device according to the invention is characterized in that the locking member comprises a rupture zone interconnecting the retaining head and the elongated body of the locking member.

Such a rupture zone, in practice, constitutes a cleavable, fusible region that tends to break under a predetermined external load on the device, especially when such a load is transmitted to the device by one of the two panels under the effect of an action external to the panels, such as an impact sustained by one of the panels.

In one embodiment, the retaining head comprises a barrel having one end joined to the elongated body so as to prolong said elongated body, the rupture zone being comprised of a narrowing of the cross section of the barrel at the level of said end.

In an advantageous manner, the retaining head comprises two diametrically opposed lugs projecting from the barrel. Such a retaining head is intended to engage in a similarly shaped hole in the second panel until the lugs are released and it thus becomes possible to rotate the locking member one quarter turn, so that the lugs come to retain the second panel on both sides of its hole. To ensure this manner of operation, the hole in the second panel thus is overall elongated, for example oblong, with a width that is slightly larger than the diameter of the barrel of the retaining head and, in any event, smaller than the distance between the ends of the lugs. A configuration of this kind results in retaining means for the second panel which, in addition to the fusibility described above, afford the possibility of relative translation between the two panels by sliding the barrel of the retaining head over the length of the hole in the second panel.

In one form thereof, the present invention provides a device for assembling a first panel and a second, superposed panel, the device being intended to pass axially through a hole provided in each panel and including a hollow-shaped fixing base equipped with clipping means for clipping onto the first panel, and a captive locking member including an elongated body mounted in the fixing base and a retaining head for retaining the second panel, characterized in that the locking member includes a rupture zone interconnecting the retaining head and the elongated body of the locking member.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a front view of an exemplary assembly device according to the invention in an unmounted state;

FIG. 2 is a front longitudinal sectional view of the device of FIG. 1;

FIG. 3 is a side longitudinal sectional view of the device of FIG. 1, taken in a section plane perpendicular to the section plane of FIG. 2;

FIG. 4 is a sectional view identical to that of FIG. 2, but in which the device is in a pre-nested state;

FIG. 5 is a side view of the device in the pre-nested state after assembly with a panel;

FIG. 6 is a view identical to that of FIG. 5, but after assembly with an additional panel; and

FIG. 7 is a front view of the device in a nested state.

Corresponding reference characters indicate corresponding parts throughout the several views. Although the exemplifications set out herein illustrate embodiments of the invention, in several forms, the embodiments disclosed below are not intended to be exhaustive or to be construed as limiting the scope of the invention to the precise forms disclosed.

### DETAILED DESCRIPTION

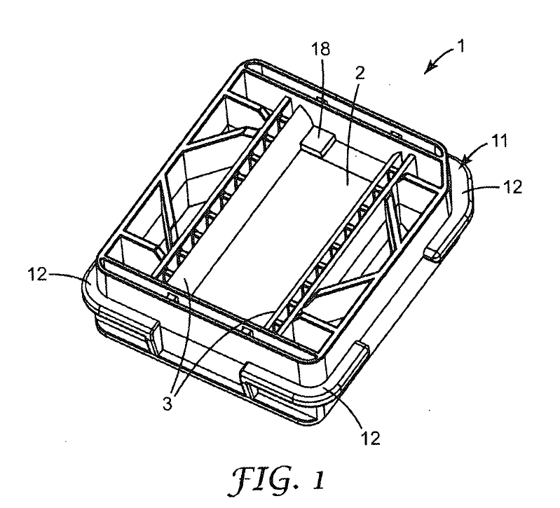

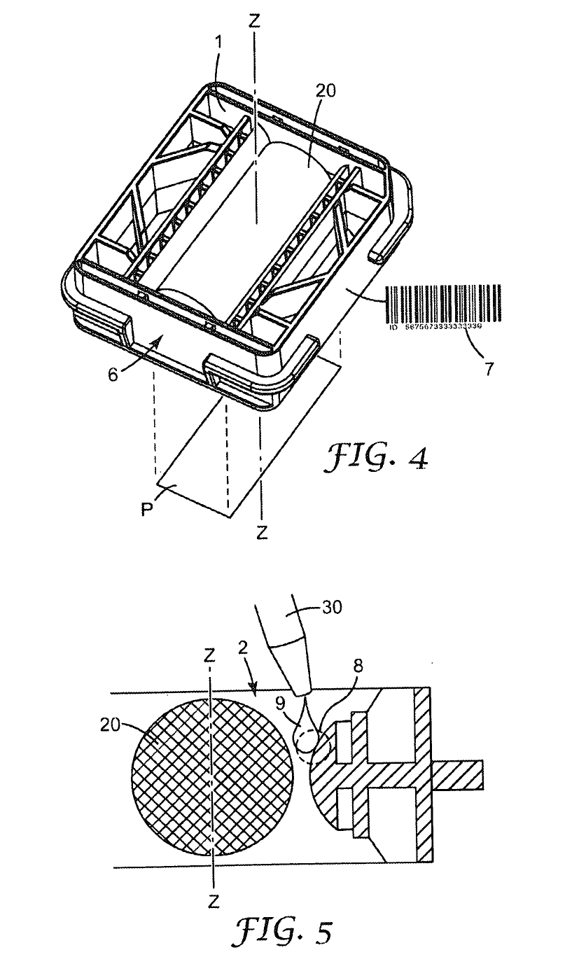

The exemplary assembly device depicted only in FIGS. 1 to 4 comprises a fixing base 10 and a locking member 11 intended to be mounted captively in the fixing base 10.

The locking member 11 is chiefly composed of an elongated body 12 and a retaining head 13. The end of elongated body 12 that is joined to retaining head 13 bears a rectangular-shaped first transverse plate 14. The opposite end of elongated body 12 from retaining head 13 bears a circular peg 15 having two parallel faces. First transverse plate 14 and circular peg 15 are joined to each other by a central rib 16 equipped on each of its edges with a boss, respectively 17a and 17b. The central rib 16 is perpendicular to the face of circular peg 15 from which it extends, and coincides with one of its diameters. Central rib 16 is likewise perpendicular to first transverse plate 14. The opposite face of circular peg 15 is equipped with a coupling member 18 capable of being joined to an external tool of the type of a hexagonal wrench or a cruciform, slot or star wrench. The external tool is capable of transmitting a rotational torque to locking member 11 through coupling member 18. The circular peg 15 and the first transverse plate 14 are disposed coaxially, their common axis D defining the longitudinal direction in which locking member 11 and, in particular, elongated body 12 extend.

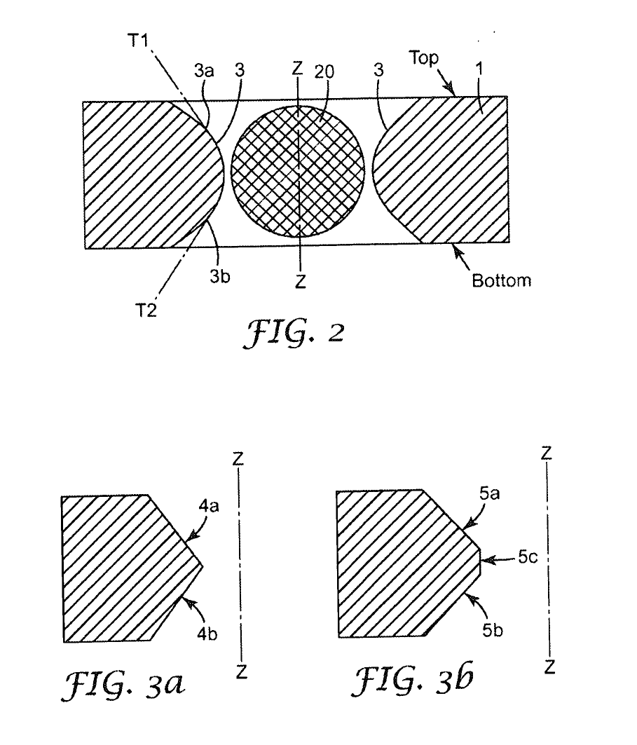

As illustrated in FIGS. 1 and 2, two flexible detents 19a and 19b disposed one on each side of central rib 16 extend from circular peg 15 toward first transverse plate 14. The flexible detents 19a and 19b are each joined at one of their ends to the face of circular peg 15 from which central rib 16 extends, and are flexible transversely, that is, toward central rib 16. Each flexible detent 19a, 19b has an inclined portion and a transverse portion. The transverse portion extends toward circular peg 15, approaching longitudinal axis D. The transverse portion extends parallel to first transverse plate 14, with a first axial offset e1, considered in the longitudinal direction. Flexible detents 19a, 19b are coplanar in a plane perpendicular to central rib 16.

Circular peg 15 has, formed in its thickness, a peripheral shoulder 29 that axially confronts first transverse plate 14 and thus retaining head 13. A chamfer 30 joins together said shoulder 29 and the face of circular peg 15 that bears coupling member 18.

Retaining head 13 comprises a cylindrically shaped barrel 20 having one end joined to elongated body 12 so as to prolong elongated body 12. Otherwise stated, the axis of revolution of the barrel 20 coincides with axis D. The barrel 20 extends perpendicularly from the center of the opposite face of first transverse plate 14 from that which is joined to central rib 16. Barrel 20 has a cross-sectional narrowing at the level of its end that is joined to first transverse plate 14. The cross-sectional narrowing is in the form of an annular neck 21 formed in the outer face of barrel 20 in that region. Retaining head 13 also bears two diametrically opposed lugs 22a and 22b that project from the barrel 20. The bottom transverse face of each of them extends parallel to first plate 14, with a second axial offset e2, considered in the longitudinal direction.

Turning now to fixing base 10, it is hollow-shaped and is composed of a cylindrical bushing 23 internally delimiting a bore 24 that comes out at one end of the bushing 23. Bushing 23 is intended to receive elongated body 12 as described hereinafter. A second transverse plate 25 of rectangular shape and of smaller thickness than first axial offset e1 extends from the other end of cylindrical bushing 23. Second plate 25 is pierced by a circular opening 26 that is centered axially with respect to the bore 24. The elongated body 12 of locking member 11 is mounted in the fixing base 10 by engaging the circular peg 15 (followed by the rest of elongated body 12) through the circular opening 26. During this operation, the chamfer 30 facilitates the engagement of circular peg 15 in circular opening 26. Consequently, after this mounting operation, axis D coincides with the axis of revolution of the cylindrical bushing 23. Axis D therefore defines the longitudinal direction in which locking member 11, fixing base 10 and, more generally, the assembly device as a whole extend.

In practice, second transverse plate 25 constitutes an axial stop operating in the direction of axis D, arranged transversely around cylindrical bushing 23. In addition, at least one maintaining fin, here two of them, labeled 27a and 27b, made of elastically deformable material, projects from the outer face of cylindrical bushing 23, with an inclined portion and a transverse portion. The inclined portion extends toward second transverse plate 25, drawing away from axis D. The transverse portion extends parallel to second plate 25, with a third axial offset e3, considered in the longitudinal direction. Maintaining fins 27a, 27b are elastically deformable transversely, that is, toward the bore 24, perpendicularly to the longitudinal direction.

Circular opening 26 also comprises two diametrically opposed, rectangular notches 28a, 28b. The shape and dimensions of each notch 28a, 28b are complementary to those of the bosses 17a, 17b of elongated body 12, such that bosses 17a, 17b are able to engage in notches 28a, 28b.

FIGS. 1 to 3 illustrate the assembly device immediately after production, during which the fixing base 10 and the locking member 11 are manufactured in one piece by injecting a plastic into a suitable mold. From the bottom of chamfer 30 on down, circular peg 15 is joined over its thickness to the contour of the circular opening 26 in the fixing base 10 by a cleavable joint. This joint is formed by a film of very thin material, so that it breaks easily. This way of fabricating the assembly device facilitates the design of the injection mold and eliminates the need to perform an extra assembly operation on a special machine. The assembly device is in an unmounted state at this point.

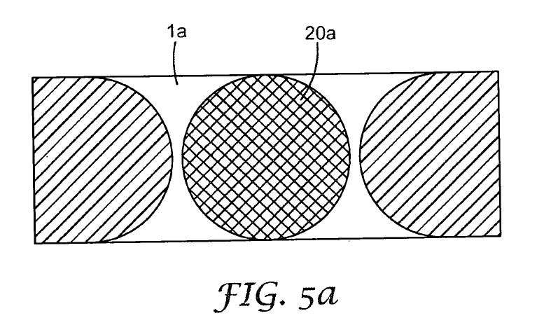

In a subsequent step, prior to any assembly with a panel, the locking member 11 is inserted partway into the cylindrical bushing 23 of fixing base 10 by forcibly engaging the chamfer 30 of elongated body 12, followed by the peripheral shoulder 29, in circular opening 26. In the course of this operation, the cleavable joint which had united fixing base 10 and locking member 11 until now is broken, and the two parts become independent of each other. To be able to engage locking member 11 in circular opening 26, the user must also take care to line up the bosses 17a, 17b with the notches 28a, 28b of circular opening 26. In an initial phase, locking member 11 must be inserted far enough into cylindrical bushing 23 so that the peripheral shoulder 29 of circular peg 15 extends longitudinally beyond circular opening 26. The diameter of circular opening 26 is larger than the overall diameter of circular peg 15 but slightly smaller than the outer perimeter of peripheral shoulder 29; this is why the engagement of elongated body 12 must be done forcibly. After the foregoing engagement, the contour of the circular opening 26 of fixing base 10 is, moreover, interposed between the peripheral shoulder 29 and the flexible detents 19a, 19b of elongated body 12, an arrangement that ensures the longitudinal retention of fixing base 10. In addition, the bosses 17a, 17b are longitudinally positioned on the edges of central rib 16 in such a way that after engagement, the bosses 17a, 17b are seated in the notches 28a, 28b of circular opening 26. Relative rotation between the fixing base 10 and the locking member 11 is consequently blocked after the engagement described above. The assembly device is then in a pre-nested state, depicted in FIG. 4.

In the subsequent course of its use, the assembly device in the pre-nested state is intended, first, to be mated with a first panel P1 and a second, superposed panel P2, so that the panels can be rigidly assembled in another subsequent step. More precisely, the panels P1 and P2 are intended to be assembled with the fixing base 10 and the locking member 11, respectively, in the manner described below. Panels P1 and P2 are generally each integral to a respective part, said parts (not shown) being intended to be assembled together in an area where panels P1 and P2 are superposed. More than one assembly device can be used to assemble the parts.

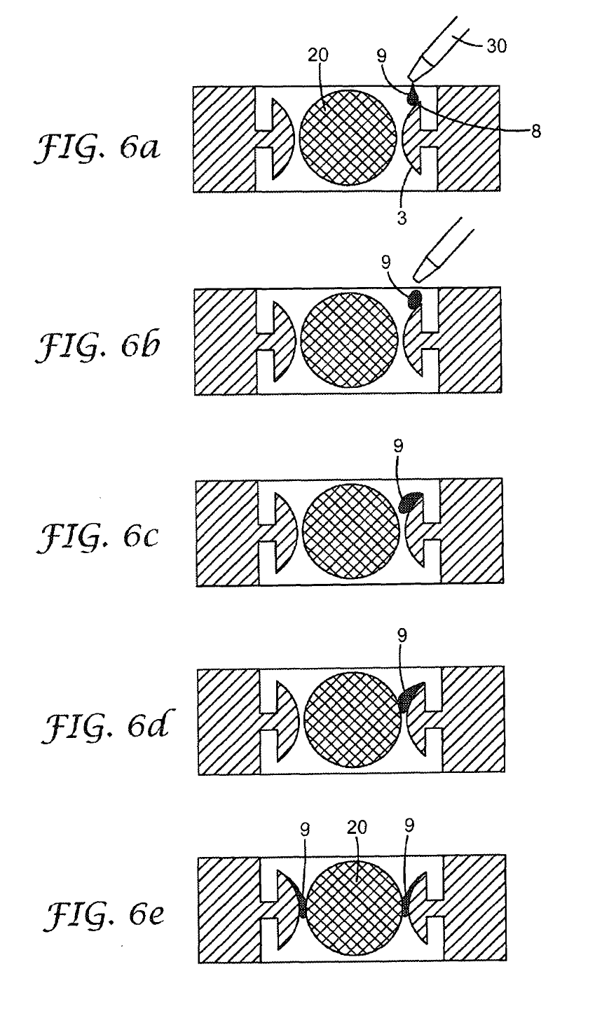

The second panel P2 (FIG. 5), whose thickness is slightly smaller than the second axial offset e2 between the lugs 22a, 22b and first transverse plate 14, comprises an overall elongated through-hole 31 having a rectangular or oblong shape, for example, with a width that is slightly larger than the diameter of barrel 20 and retaining head 13 and, in any event, smaller than the distance between the ends of the lugs 22a, 22b. The length of hole 31, on the other hand, is greater than the distance between the ends of lugs 22a, 22b. Hole 31 is therefore similar in shape to retaining head 13, with slightly larger dimensions to create mounting play.

To assemble second plate P2 on locking member 11, retaining head 13 is engaged longitudinally in hole 31 until lugs 22a, 22b attain a released position in which panel P2 is situated longitudinally between first transverse plate 14 and lugs 22a, 22b. The user then manipulates the retaining head 13 by hand to cause the locking member 11 to rotate one quarter turn. Since the bosses 17a, 17b are seated in the notches 28a, 28b of circular opening 26 during the rotation of locking member 11, this movement of locking member 11 is accompanied by a corresponding movement of fixing base 10. After rotation (FIG. 5), the lugs 22a, 22b serve to retain second panel P2 on both sides of its hole 31. The assembly of second panel P2 is complete. A configuration of this kind results in retaining means for retaining second panel P2 that ensure the possibility of relative translation between second panel P2 and the assembly device by sliding the barrel 20 of retaining head 13 over the length of the hole 31 in the second panel P2.

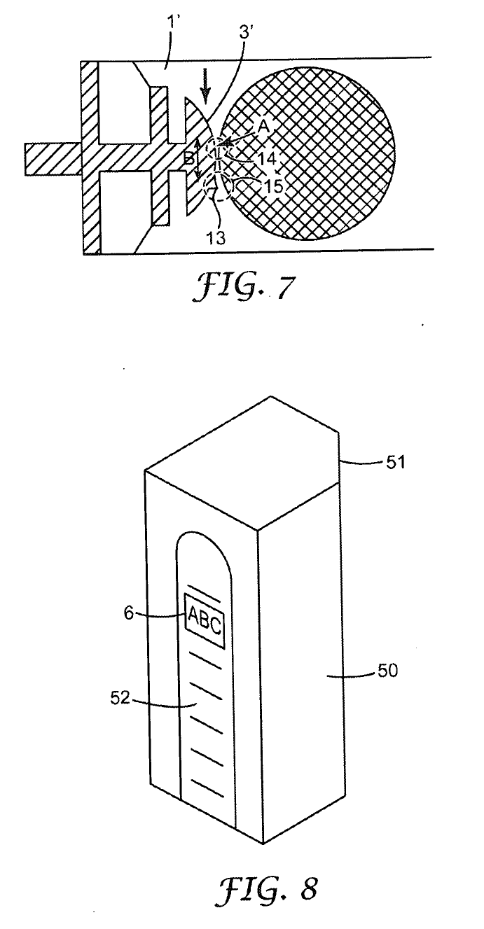

First panel P1 (FIG. 6), whose thickness is slightly smaller than the third axial offset e3 between second transverse plate 25 and the transverse portions of the maintaining fins 27a, 27b, comprises a through-hole 32 having a circular shape of slightly larger diameter than the outer diameter of the cylindrical bushing 23. This configuration makes it possible to introduce the bushing 23 into the hole 32. As first panel P1 slides along bushing 23, the maintaining fins 27a, 27b bend in the transverse direction, while the contour of hole 32 slides along the inclined portions of the fins 27a, 27b until said inclined portions, and thus the fins 27a, 27b, are released. The maintaining fins 27a, 27b then return by elastic rebound to their natural configuration, such that their transverse portions come into contact with one of the faces of first panel P1. The other face of first panel P1 is in contact with second plate 25, which can be provided for this purpose with a plurality of distributed bulges 33. The first panel P1 thus is clamped between the second plate 25 and the maintaining fins 27a, 27b, and the assembly of first panel P1 is complete (FIG. 6). Maintaining fins 27a, 27b and second transverse plate 25 constitute clipping means for clipping first panel P1 to fixing base 10.

In this state, the rotation of fixing base 10 relative to first panel P1 is impossible because of the clipping means. As explained previously, the rotation of locking member 11 relative to fixing base 10 is also impossible. Since the panels P1 and P2 are superposed and are fixed in rotation relative to each other, the rotation of retaining head 13 relative to second panel P2 is impossible, thus safety-locking the assembly. In addition, in the absence of an external axial load, the flexible detents 19a, 19b of elongated body 12 prevent the free translation of locking member 11 relative to fixing base 10.

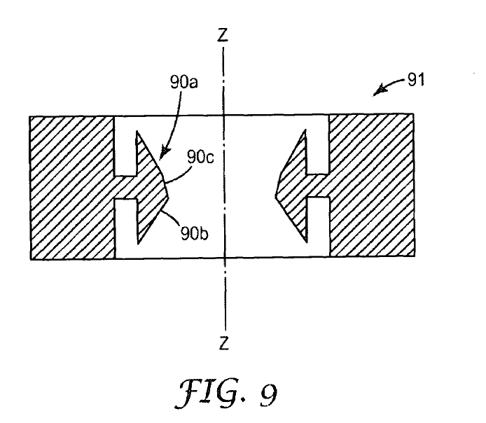

To complete the assembly of panels P1 and P2, locking member 11 is inserted all the way into fixing base 10 by forcibly engaging elongated body 12 in cylindrical bushing 23 (in its bore 24). As the second transverse plate 25 of the base 10 slides along the elongated body 12, the flexible detents 19a, 19b bend in the transverse direction, while the contour of the circular opening 26 slides along the inclined portions of the detents 19a, 19b until said inclined portions, and thus the detents 19a, 19b, are released. The detents 19a, 19b then return by elastic rebound to their natural configuration, such that their transverse portions come into contact with one of the faces of second plate 25. The other face of second plate 25 is in contact with first plate 14. Second plate 25 is therefore held in place between first plate 14 and the flexible detents 19a, 19b. The assembly of the first and second panels P1 and P2 is complete (FIG. 7), and the panels P1 and P2 are braced by the superposition of the two transverse plates 14 and 25. The assembly device is now in the nested state, and the shapes of the parts to which panels P1 and P2 are integral are such that the possibility of movement of the second panel P2 relative to the assembly device (and thus relative to the first panel P1, via the clipping means) is eliminated.

When the assembly device is in the nested state, the circular neck 21 of the barrel 20 of retaining head 13 constitutes a rupture zone interconnecting the retaining head 13 and the elongated body 12 of locking member 11. Such a rupture zone, in practice, constitutes a cleavable, fusible region that tends to break under a predetermined external load applied to the assembly device, especially when such a load is transmitted to the device by one of the two panels P1, P2 under the effect of an action external to the panels P1, P2, such as an impact sustained by one of the panels P1, P2.

Any other equivalent means of creating such a rupture zone can be used, for example a region in which the material is locally different and more fragile, a region having a dotted-line-type discontinuous joint, a region containing a plurality of longitudinal support webs, etc.

The assembly device described hereinabove further makes it possible to disassemble the panels P1 and P2. With the device in the nested state, the user introduces an external tool into the bore 24 of cylindrical bushing 23, from the open end thereof, until it is inserted in the coupling member 18 of circular peg 15. The user then transmits a rotational torque to the locking member 11 so as to rotate it one quarter turn relative to the fixing base 10 (and thus relative to second panel P2). The retaining head 13 is then guided by the hole 31 in second panel P2, and second panel P2 can be removed from the assembly device, which, for its part, remains clipped to the first panel P1.

A second effect of this relative rotation between the locking member 11 and the fixing base 10 is that the flexible detents 19a, 19b of elongated body 12 are brought into registration with the notches 28a, 28b of circular opening 26. This disengagement of the flexible detents permits a longitudinal translation of locking member 11 in relation to fixing base 10 that tends to move the first and second transverse plates 14 and 25 away from each other. This translation is limited by the bosses 17a, 17b coming into contact with the second transverse plate 25 of fixing base 10, enabling locking member 11 to rotate freely again. Another quarter-turn rotation causes the bosses 17a, 17b to be seated back in the notches 28a, 28b, and the peripheral shoulder 29 to come into contact with the second transverse plate 25. The locking member 11 is captive and can be used for a subsequent assembly.

The possibility of relative movement of the second panel P2 with respect to the assembly device as long as the device is not in the nested state is particularly advantageous when the first panel P1 is a portion of an automobile chassis and the second panel P2 is a fender portion of the automobile. With such a pair of panels P1 and P2, the system constituted by the panels P1 and P2 assembled on the assembly devices and by the devices all in the pre-nested state is to be processed in a cataphoresis-type processing oven before all the devices are placed in the nested state. During this operation, the high temperatures to which the second panel P2 (the fender) is exposed induce dimensional deformations of panel P2, and the possibility of relative movement of the second panel P2 relative to the assembly devices permits the transverse displacements of second panel P2 during its deformation.

When the second panel P2 is an automobile fender portion or bumper portion, the rupture zone interposed between the retaining head 13 and the elongated body 12 clearly serves to improve the safety of the prior-art devices by making it possible to release the fender or the bumper, respectively, in the event of an accident, thus creating an impact energy absorption zone.

It goes without saying that the step of assembling the second panel P2 with the aid of the retaining head 13 can be performed after the step of assembling the first panel P1 with the aid of the clipping means without departing from the scope of the invention. Nor is the invention limited to the previously described shape of the retaining head 13. In particular, a retaining head 13 that is placed in retention mode by rotating it one quarter turn is not exclusive; in this regard, it is possible to contemplate a retaining head that automatically goes into retention mode, for example a circular retaining head.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1-11. (canceled)

12. A device for use in assembling first and second superposed panels by passing axially through holes respectively provided in the panels, said device comprising:
a hollow fixing base including clipping means for clipping onto the first panel; and
a locking member including an elongate body mounted within said fixing base and a retaining head for retaining the second panel, said locking member further including a rupture zone interconnecting said retaining head and said elongated body.

13. The device of claim 12, wherein said retaining head includes a barrel extending from said elongate body and having one end thereof joined to said elongate body, and said rupture zone includes a narrowing of a cross section of said barrel at said end.

14. The device of claim 13, wherein said retaining head includes two diametrically opposed lugs projecting from said barrel.

15. The device of claim 12, wherein said elongated body includes a first end joined to said retaining head, said first end including a first transverse plate.

16. The device of claim 12, wherein said elongate body includes a second end opposite said first end, said second end including a circular peg having a coupling member engageable by an external tool.

17. The device of claim 16, wherein said first transverse plate and said circular peg are joined by a central rib, said central rib including opposite edges each having a boss.

18. The device of claim 17, wherein said central rib includes opposite sides and two flexible detents oriented transversely to said central rib and extending respectively from said opposite sides, said detents also extending from said circular peg toward said first transverse plate.

19. The device of claim 16, wherein said circular peg includes a peripheral shoulder axially confronting said retaining head.

20. The device of claim 12, wherein said fixing base includes a cylindrical bushing having a bore, and said clipping means includes an axial stop arranged transversely around said bushing and at least one transversely elastically deformable maintaining fin.

21. The device of claim 20, wherein said axial stop includes a second transverse plate extending from an end of said cylindrical bushing, said second transverse plate including a circular opening centered axially with respect to said bore of said cylindrical bushing.

22. The device of claim 21, wherein said circular opening includes two diametrically opposed notches.
